(19) United States
(12) Patent Application Publication
(10) Pub. No.: US 2013/0038930 A1
(43) Pub. Date: Feb. 14, 2013

(54) ALIGNMENT APPARATUS

(71) Applicant: Kevin Jon Vent, Clifton Springs, NY (US)

(72) Inventor: Kevin Jon Vent, Clifton Springs, NY (US)

(73) Assignee: Gradient Lens Corporation, Rochester, NY (US)

(21) Appl. No.: 13/205,023

(22) Filed: Aug. 8, 2011

(51) Int. Cl. G02B 23/24; F16C 1/26

(52) U.S. Cl. 359/362; 74/502.6

(57) ABSTRACT

An apparatus includes a stationary plate comprising an opening, a guide retained in the opening and pivotable relative to the stationary plate and a cable. The guide includes a through hole and the cable is disposed and axially slidable in the through hole.

### BACKGROUND OF THE INVENTION

1. Technical Field

The present invention relates to alignment apparatus. More specifically, the invention relates to an apparatus for aligning cables through a stationary plate, for example, in a borescope.

2. Description of Related Art

A borescope having a movable distal tip is known in the art. In such an apparatus, a user actuates a lever proximate a handle to effectuate movement of the tip. More specifically, in conventional apparatus, the lever is operatively connected to a pulley about which a cable is disposed. Opposite ends of the cable then are attached to positions on the distal tip. Movement of the pulley causes one end of the cable to “pull” on a portion of the tip. This “pulling” effectuates relative movement of the two tip portions to which the cable ends are attached, thereby pivoting the tip. In other embodiments, ends of the cable wrapped about the pulley are in further communication with another cable or cables that in turn are in communication with the distal tip.

The distal tip is spaced from the pulley, and there commonly are components of the borescope disposed between the distal tip and the pulley. For example, a stationary plate, such as a bulk head, is disposed intermediate the tip and the pulley, and the cable must bypass that plate. Conventionally, holes are drilled through the stationary plate and the cables are passed through these holes. While this solution is relatively inexpensive and straightforward it has inherent drawbacks.

For instance, the cables have a tendency to contact an edge formed at the junction of the outside of the hole and the face of the plate. This results in wearing, and in some instances binding, of the cable. Both are undesirable, as the life of the borescope is reduced or the borescope may be entirely unusable. Moreover, binding of the cable detracts from the precision “feel” of the articulation mechanism and hinders the operator's ability to finely control the tip's position.

A conventional approach to solving this problem have been to affix a sleeve in the holes, to prevent contact of the cable with the plate. However, the cable still wears on the sleeve or vice-versa, leading to still decreased life of the assembly.

The main source of the problem is that the cables are spaced farther apart about the pulley than at the tip. So, the cables pass through the plate at an angle. The angle is usually compound, because in addition to the cables coming gradually closer to each other as they approach the tip, the tip also is not co-planar with the pulley so the cables are usually canted relative to a central axis of the borescope, extending from the tip through the body.

In other conventional applications, engineers have minimized wear on the cables by calculating the angle at which the cable passes through the plate and drilling the hole at that angle. While this approach may yield favorable results, the tooling and engineering is costly.

Thus, there is a need in the art for an improved adjustment assembly for a borescope that reduces cable degradation due to rubbing against a stationary plate through which the cable must pass.

There also is a need in the art for an improved adjustment assembly that allows for easier fabrication, including machining, assembly, and disassembly for any application in which a member passes through and moves relative to an object.

There also is a need in the art for an improved adjustment assembly in a borescope that has decreased friction and binding to provide a smoother, more precise operation for a user.

### SUMMARY OF THE INVENTION

The present disclosure addresses the foregoing needs in the art by providing an improved adjustment assembly.

In one aspect, an apparatus includes a stationary plate comprising an opening, a guide retained in the opening and pivotable relative to the stationary plate and a cable. The guide includes a through hole and the cable is disposed and axially slidable in the through hole.

In another aspect of the disclosure, a borescope having an articulatable tip actuated by a cable includes first and second cable segments attached to the tip, a stationary plate and first and second guides. The stationary plate is spaced from the tip and has a first opening and a second opening. The first guide is captured in the first opening and the second guide is captured in the second opening. Each of the first guide and the second guide is free to swivel in its respective opening. The first cable segment is passed through and slidable within the first guide and the second cable segment is passed through and slidable within the second guide.

In a still further aspect of the disclosure, a borescope includes a tip, first and second cable segments terminating at the tip and movable to impart a motion on the tip, a stationary plate spaced from the tip and including a first opening having a first axis and second opening spaced from the first opening and having a second axis, first and second guides captured, respectively, in the first and second openings, and first and second sleeves. Each of the first and second guides includes a through hole having a through hole axis and the first and second guides are pivotable within the first and second openings to vary an angle between the respective through hole axis and the first and second axes. The first and second sleeves are disposed in and fixed relative to the through holes of the respective first and second guides. The first cable segment extends through and is slidable with respect to the first sleeve and the second cable segment extends through and is slidable with respect to the second sleeve.

These and other features, aspects and embodiments of the invention will be better understood with reference to the appended drawing figures and following detailed description of the invention in which preferred embodiments of the invention are shown and described.

### BRIEF DESCRIPTION OF THE DRAWING FIGURES

FIG. 1 is a perspective, partial view of a borescope including an alignment apparatus according to an embodiment of the invention.

FIG. 2 is a perspective view of an adjustment assembly of the borescope illustrated in FIG. 1.

FIG. 3 is a perspective view of a portion of the alignment apparatus disclosed in FIG. 1.

FIG. 4 is an exploded view of the portion of the alignment apparatus illustrated in FIG. 3.

FIG. 5A is a perspective view of an alignment apparatus according to another embodiment of the invention.

FIG. 5B is a partial, plan view of the apparatus illustrated in FIG. 5A, taken along section B in FIG. 5A.

### DETAILED DESCRIPTION OF THE INVENTION

Preferred embodiments of the disclosure now will be described with reference to the Figures.

Although the illustrations and the following discussion will be primarily concerned with an application concerning borescopes, this is for illustration only. One of ordinary skill in the art will appreciate that the apparatus and methods disclosed can be used in many applications in which an article must pass through and move relative to a second article.

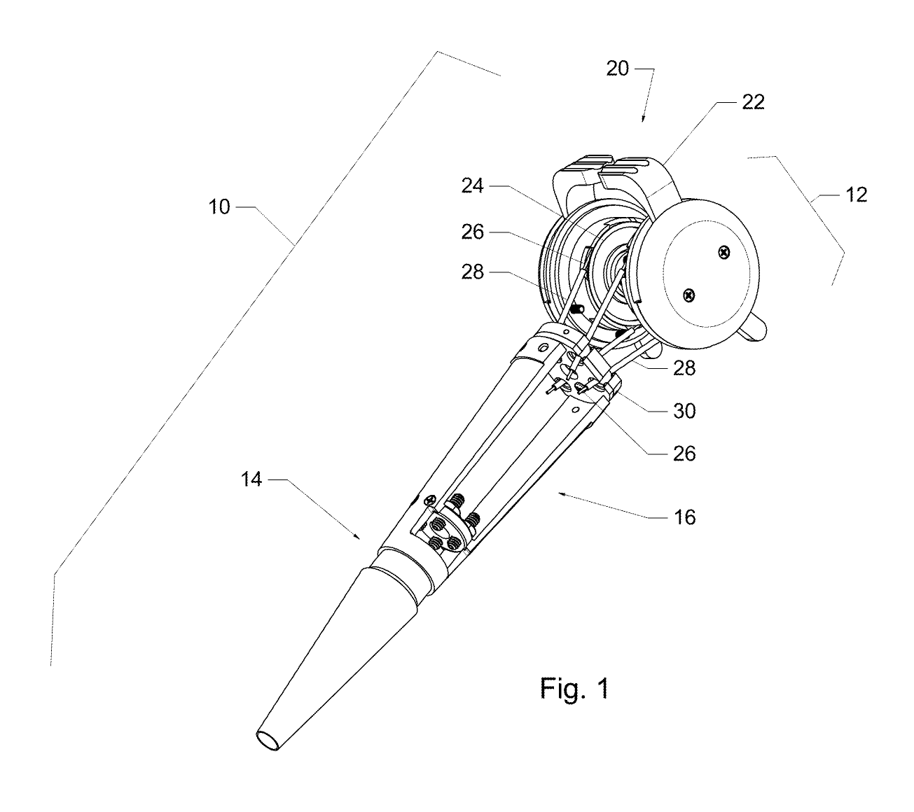

FIG. 1 is a perspective view of a portion of a borescope 10 implementing one embodiment of the invention. The borescope 10 generally includes a user interface 12 and a distal tip 14 spaced from the interface. A throat 16 extends from the interface 12 to the distal tip 14. A cover or body, which is not shown in the Figures for ease of illustration purposes, is positioned over one or more of the distal tip 14, the throat 16, and the user interface 12. The cover generally keeps dust and other debris from contacting the components of the borescope 10 and may, by itself or with additional structure, serve to position and secure the components making up the borescope. Other components of the borescope also are not shown in the Figures, for ease of illustration. Such components include an insertion tube, details of an articulating tip, an image guide, and an eyepiece.

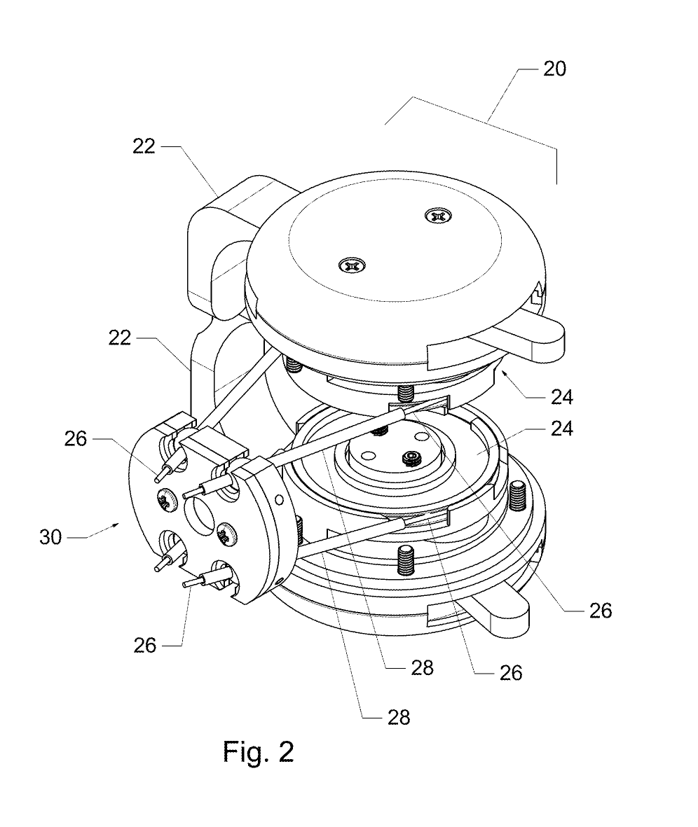

An adjustment assembly 20 is disposed at the user interface 12 of the borescope 10. FIG. 2 also illustrates the adjustment assembly 20. The illustrated adjustment assembly 20 is for use in a four-way articulating scope and generally includes two levers 22, each communicating with a pulley 24 such that movement of one of the levers effectuates a rotation of the corresponding pulley 24. In the illustrated example, each of the levers is disposed coaxially with and in direct communication with its respective pulley such that a rotation of the lever 22 results in a corresponding rotation of the pulley 24. In other embodiments, reducers, gears, transmissions or similar devices may be used to cause more or less rotation of the pulley relative to an adjustment of the lever. Moreover, although the illustrated embodiment shows that the lever 22 is rotated to rotate the pulley 24, an arrangement may be provided in which the lever is actuated linearly to effectuate a rotation of the pulley, using known transmission techniques, such as, for example, worm gears. A brake may also be in communication with each pulley, to lock the pulley in a desired position.

As illustrated, a cable 26 is disposed about each pulley 24. The opposite ends of the pulley extend from the pulley 24 toward the distal tip 14 such that two cable segments are disposed between the tip and the pulley, one extending from each side of the pulley. For purposes of illustration, FIGS. 1 and 2 show the cables being truncated, although in an actual borescope, the ends of the pulley extend to and are in communication with a movable portion of the distal tip. Specifically, the opposite ends of each pulley may be connected at spaced positions to the distal tip of the borescope 10. The cable 26 is taut about the pulley. The cable preferably is a braided metal cable, such as a steel cable, although other types of cable may be used.

In operation, a user actuates the lever 22 to cause a rotation of the pulley 24. The rotation of the pulley 24 causes the taut cable 26 to move, too. Specifically, one end of the pulley is “pulled” toward the base, while the other end of the cable is “pushed” away from the pulley 24. Because the ends are in operative communication with a movable portion of the distal tip, movement of that portion of the tip results.

In the illustrated embodiment, two levers, pulleys and cables are provided, although some borescopes may include only one of each of these components. As will be appreciated, the illustrated embodiment provides for twice the number of planes of motion as those apparatus including only one lever and associated adjustment components. The disclosure is not limited to the illustrated embodiment, and can be used with any number of cables and associated components. The disclosure also is not limited to pairs of cable segments. For example, one end of the cable could be fixed to a portion of the pulley, such that only a single cable segment extends to the distal tip.

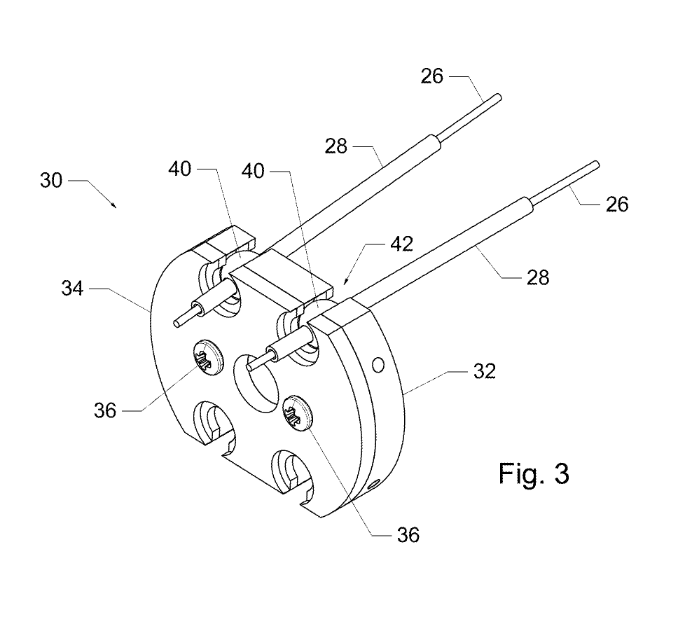

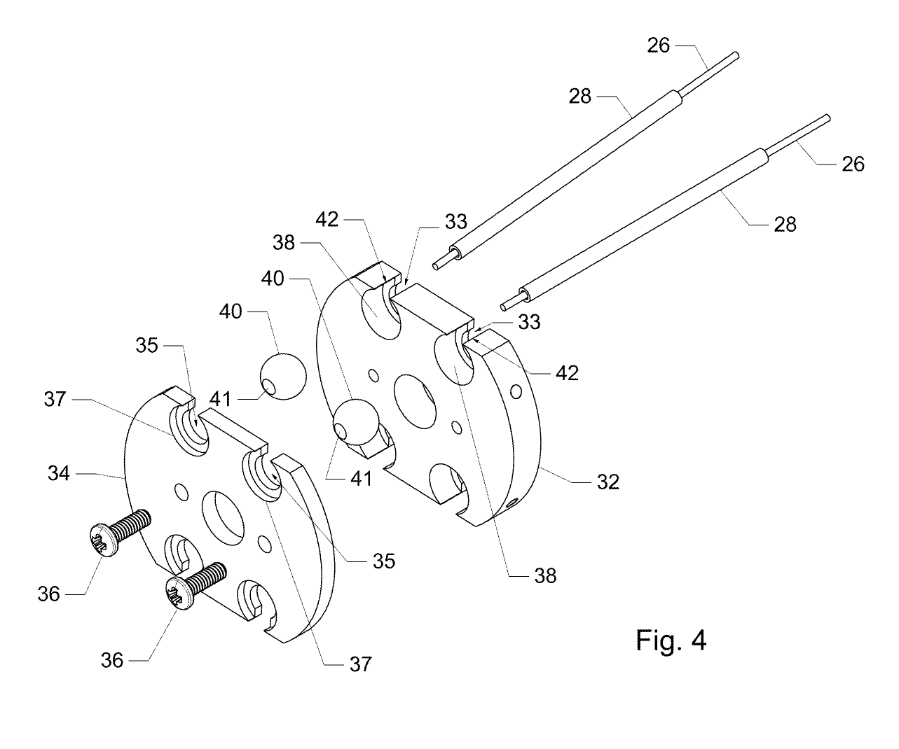

As noted above, in some examples the cable 26 must bypass components aligned along the throat 16 of the borescope 10. For example, in conventional borescopes, a stationary plate is provided with a number of holes corresponding to the number of cable segments required to pass through the plate. In the present example, that conventional plate is replaced by a plate assembly 30, which is illustrated in context of a borescope in FIG. 1, in context of the adjustment assembly of the borescope in FIG. 2, in perspective view in FIG. 3, and in an exploded view in FIG. 4.

The plate assembly 30 generally includes a first or back plate 32 and a second or front plate 34. As illustrated, the back and front plates 32, 34 abut, with a front face or surface of the back plate 32 contacting a back face or surface of the front plate 34. The plates 32, 34 are held fixed to each other using machine screws 36. Although in the illustrated embodiment the front surface of the back plate and the back surface of the front plate are both planar, those surfaces could have other shapes or characteristics. For example, the surfaces could be keyed to each other or could have some other mating features. Moreover, although machine screws are illustrated for holding the two plates together, any known fastener may be used. It may be preferable in some applications to allow for selective disassembly of the first and second plates, so screws, pins, or other releasable fasteners may be used in those applications. In other applications it may not be desirable to have the plates separable so an adhesive, rivets, or other more permanent fastener may be used.

A plurality of back plate holes 33 are formed through the back plate 32 and a corresponding plurality of front plate holes 35 are formed through the front plate 34. When the back and front plates 32, 34 are abutted, the back plate holes 33 align with the front plate holes 35 to create through holes extending through the entire plate assembly. It is through these holes that cable segments will be passed, so although the illustrated embodiment shows four such holes, more or less may be required depending upon the application, and more particularly depending upon the number of cable segments to extend through the plate. Again, although the present disclosure is defined in terms of a borescope, other applications of the principles may be readily realized because of this disclosure. Thus, regardless of the application, the number of through holes generally correspond to the number of cable segments to be passed through the stationary member, in this case, the plate.

A corresponding number of bores 38 are formed coaxially with the back plate holes 33 in the front face of the back plate, that is, the surface of the back plate 32 that abuts the front plate 34. When the front and back plates are abutted, the bores 38 form a pocket or confined space “inside” the plate assembly. More specifically, because the front plate holes 35 align with the back plate holes 33 to form an opening or hole through the entire plate assembly, that hole has a stepped profile with the bore forming a larger diameter opening between two relatively smaller diameter openings provided by the back plate holes 33 and the front plate holes 35. As will be appreciated, substantially the same configuration would be achieved in the assembled plate assembly 30 by forming the bores 38 in the back surface of the front plate 34 or by forming bores in both the front surface of the back plate 32 and the back surface of the front plate 34.

Although illustrated as such, it is not required that the bores 38 be formed as cylindrical bores. For example, the bores could be slotted or they could have tapered sidewalls. Regardless of their construction, the bores 38 are sized to form a pocket to receive a pivoting guide 40. In the instance of the bores 38 being cylindrical as illustrated, the bores 38 preferably have sufficient depth and circumference to receive and hold the pivoting guide 40 therein when the plates 32, 34 are abutted.

The pivoting guide 40 has a generally frusto-spherical shape with a guide through-hole 41 disposed therethrough. As will be described in more detail below, the guide through-hole 41 preferably is sized sufficiently to allow the cable to pass therethrough. When disposed in the pocket created by the bores 38, the guide 40 will be retained in the pocket. In the illustrated example, this is because the guide's outer diameter is greater than the diameter of the back plate hole 33 and of the front plate hole 35, but is smaller than the diameter of the bore 38, such that the guide will rotate, pivot and otherwise move about in the pocket. In a working embodiment created by the inventors, the outer diameter of the guide 40 is about 0.156 inches, the diameter of the bore is about 0.188 inches and the depth of the bore is about 0.100 inches. As the depth and/or diameter of the bore increase relative to the size of the guide, the guide 40 will be capable of additional, linear movement, e.g., perpendicular and parallel to the axis of the bore. In one embodiment this linear movement is preferably minimized by allowing minimal clearance between the bore 38 depth and diameter and the guide 40. In other embodiments it may be desirable to allow for more “play” of the guide 40 in the bore 38, so more clearance between the guide 40 and the bore 38 could be incorporated.

In operation, the guide 40 is placed in the bore 38 with the back and front plates 32, 34 separated. The plates are then abutted and fixed to each other using the machine screws 36. Although not shown, in one embodiment, the appropriate cable 26 segments are inserted through the hole 41 of the guide 40. When the plate assembly 30 is aligned along the throat 16 between the tip 14 and the body 12, as shown in FIG. 1, distal ends of the cable 26 are affixed to the tip. Because the guides 40 are free to move in the bores 38, the guides 40 pivot to allow for self-alignment of the cables. So, when the cable 26 moves as a result of adjustment by the user, the corresponding guide(s) 40 will move also. In a preferred embodiment, the guide 40 moves in its respective bore 38 to adjust an axis of the guide hole 41 to be collinear with a line between a portion of the cable on the body 12 side of the plate assembly 30 and a portion of the cable 26 proximate the tip. The axis of the guide hole 41 thereby adjusts to allow for unobstructed passage of the cable 26 through the plate assembly 30. This is in contrast to conventional applications in which the hole through the plate through which the cable passes has a fixed axis. In those conventional applications, the hole cannot always be aligned with a longitudinal axis of the cable, because that axis changes depending upon the application and adjustment by the user.

The guide preferably is positioned and pivotable such that it can align its hole's axis with a straight line between the location at which the cable leaves the pulley and the cable's attachment point at the distal tip, thereby maintaining that cable segment straight between the pulley and that attachment point. However, it may not at all times be possible for the cable to extend in a straight line from the pulley to the distal tip and therefore it may not be possible in some embodiments to completely eliminate rubbing of the cable 26 on the edges circumscribing the hole 41 of the guide 40, but even in those applications the guide 40 according to the present disclosure pivots to reduce this rubbing.

Although a preferred embodiment involves passing the cable 26 through the guide 40, the illustrated embodiment includes a sleeve 28 through which a portion of the cable 26 passes. As shown, a sleeve 28 is provided for each guide 40. An end of the sleeve 28 may abut the guide 40 proximate the guide hole 41, or, as in the illustrated embodiment, the guide hole 41 is sized to receive the sleeve 28 therein. Thus, in the illustrated embodiment, the sleeve 28 is disposed in the hole 41 and the cable 26 is disposed to extend through and move axially, or slide, in the sleeve 28.

In one embodiment of the invention, the sleeve 28 preferably is fixed to the guide 40. For example, an end of the sleeve 28 is inserted into the hole 41 of the guide 40 and the sleeve is then adhered or otherwise fixed to the guide 40. Different adhering means may be used, generally depending upon the materials from which the sleeve and guide are made. In one embodiment, the guide is a self-lubricating brass guide and the sleeve is a stainless steel wire wrapped into a helix, and the two pieces are held together using an epoxy. In other embodiments, the guide could be made from any metal, polymer, mineral, ceramic or other material which could be formed to the desired shape and allow for substantially unrestricted movement with respect to contacting components. The sleeve could also be made from any number of components, such as any metal polymer, mineral, or ceramic, but the sleeve preferably is flexible to allow for smooth transition of the cable therethrough. Depending upon the material selection, the sleeve 28 could be fastened to the guide 40 using such techniques as welding, press fitting, epoxy, soldering, or mechanical fasteners such as screws, set screws, bolts, dowel or taper pins, nails, or the like.

In the illustrated embodiment, the sleeve 28 extends from the guide 40 to a position near but not contacting the pulley 24. Thus, the pulley is disposed between the sleeves 28, along the path of the cable 26. In this manner, the sleeve 28 protects the cable 26 from becoming exposed to dust, debris and the like that may accumulate in the borescope body and could hinder normal operation of the borescope. As also shown, the sleeve 28 also extends through the guide 41 toward the distal tip 14. In other embodiments the sleeve 28 may not extend from the guide toward the distal tip, or it could extend further toward the tip.

When the sleeve 28 is incorporated, as in the illustrated embodiment, the plate assembly may be constructed substantially as described above. That is, with the back plate 32 and the front plate 34 separated, the guide 40 is placed in the bore 38. The sleeve 28 may be inserted into the guide 41 prior to placement in the bore 38, in which case the sleeve must be threaded through the back plate hole 33 while the guide is placed in the bore. Alternatively, the sleeve could be inserted into the guide with the guide already disposed in the bore 38. Once the guide is placed in the bore, with or without the sleeve already inserted therein, the machine screws 36 affix the front plate 34 and the back plate 32 to capture the guide 40. The inventors have found that, when it is desired to affix the sleeve 28 to the guide 40, it is generally easier from an assembly standpoint to so affix the sleeve 28 to the guide 40 before inserting the completed assembly into the bore. It may be difficult to affix the sleeve to the guide when the guide is already in the bore 38 or generally when other components are present.

As noted above, in a preferred process, the sleeve is affixed to the guide before insertion into the plate assembly. To this end, and so that the entire length of the sleeve need not be threaded through the back plate hole 33, a slot 42 also is formed in the back plate 32 in connection with each back plate hole 33. More specifically, the slot 42 extends the back plate hole 33 to a side of the back plate 32. A corresponding slot also may be provided to create an opening from each bore 38 to the side of the back plate 32, although in the illustrated embodiment, the distance from the center of each bore 38 to the closest side of the back plate 32 is less than the diameter of the bore, so formation of the bore naturally creates an opening in the side of the back plate 32. As a result of the slot 42, the sleeve 28 need not be threaded through the back plate hole 33 when the guide 40 is inserted into the bore 38, but instead can be slid through the slot 42 into the back plate hole 33. Thus, with the plates 32, 34 separated, the guide 40 is put in position aligned with the respective bore 38 and the sleeve is disposed in the slot 42. Once in this position, the plates 32, 34 are affixed using the machine screws 36. As will be appreciated, the slot must be wider than the sleeve to allow for insertion of the sleeve therethrough, but the slot should be narrower than the outer diameter of guide 40, such that the guide 40 is maintained in the bore 38, and does not slip out of or otherwise become disengaged from the plate assembly. In an alternative embodiment, the slot 42 could be wider than the outer diameter of the guide 40, but the slot could be covered, for example, using a plate or the like (not shown) to retain the guide in the slot. A plate or the like (also not shown) could be placed over the opening in the side of the back plate comprising the slot 42, for example, so the sleeve will not pivot out of the slot once inserted. In such an embodiment, the slot could be selectively removable to allow for selective removal of the guide 40, the sleeve 28, and/or the cable 26.

Similar to the back plate slot 42, the front plate 24 includes a front plate slot 44. The front plate slot 44 allows for similar insertion of the sleeve into the front plate hole 35. That is, when the sleeve 28 extends from the guide 40 toward the tip 14, it can be inserted into the front plate hole 35 via the slot through the side of the front plate 34, obviating the need to thread the sleeve 28 through the front plate hole 35.

As also illustrated in the Figures, the front plate holes 34 also include a counter bore 37. This counter bore preferably is provided to increase the range of motion of the guide/sleeve/cable combination. More specifically, the counterbore preferably provides for greater movement of the sleeve and/or cable before it/they contact the front plate. A similar result could be obtained using a countersink or even by minimizing the thickness of the front plate. Similarly, the back plate could include a counterbore, countersink or the like on its back surface.

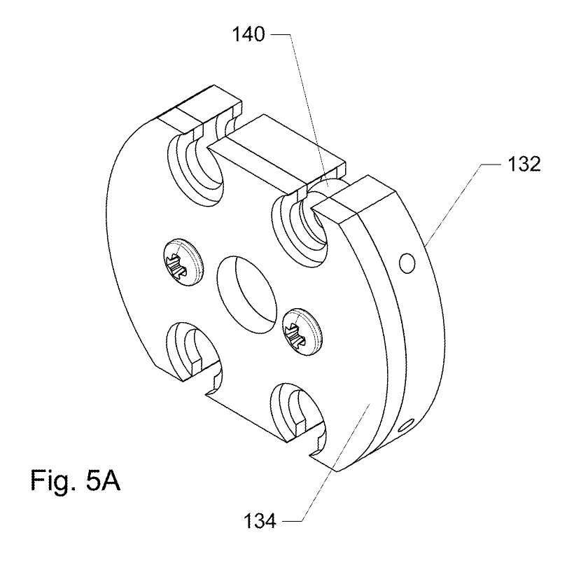

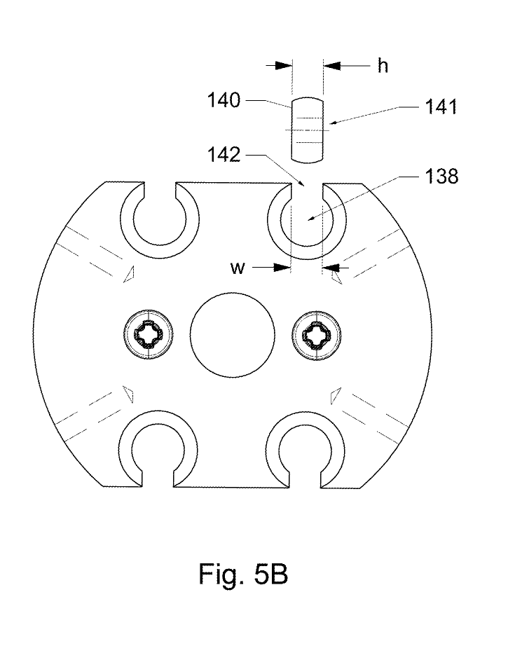

In the embodiments described above, the plates 32, 34 need be separated to receive the guide 40 therein. However, in other embodiments, this is not the case. Such an embodiment is illustrated in FIGS. 5A and 5B. There, the back plate 132 and the front plate 134 are substantially identical to those components in the previously illustrated embodiments. However, the guide 140 is slightly changed. The guide 140 still has a frustospherical shape, but its height h is less than a width w of the slot 142. This is shown in detail in FIG. 5B. In this embodiment, the guide 140 is turned such that the axis of its hole 141 is perpendicular to the axis of the bore 138. So positioned, the guide 140 can be inserted, through the slot 142, into the bore 138. Once so inserted, the guide 140 is rotated 90-degrees to align its hole's axis with the axis of the bore 138, in a position to accept a cable or sleeve/cable combination. In this embodiment, the plates need not be separated to insert and remove the guide 140. Accordingly, the plates could actually be a single plate, without diverting from the spirit and scope of the invention.

Similar to the embodiment just discussed, a guide could be provided that has an outer diameter that is only slightly larger than the width of the slot. In this example, the guide could be pressed through the slot and into the bore for retention therein. This embodiment also could incorporate only a single plate instead of two plates. The disclosure is not limited to an assembly including multiple plates. The plate assembly could include only a single plate in the assembly.

As noted above, components of the apparatus can be made from any number of materials. In a preferred embodiment, the plates are fabricated from aluminum, the guide is brass, the cable is steel, and the sleeve is a wound stainless steel wire.

The foregoing embodiments of the present invention are provided as exemplary embodiments and are presently best modes for carrying out the invention. Modifications of these embodiments will be readily apparent to those of ordinary skill in the art. The invention is not intended to be limited by the foregoing embodiments, but instead is intended to be limited only by the appended claims.

1. An apparatus comprising:
a stationary plate comprising an opening;
a guide retained in the opening and pivotable relative to the stationary plate, the guide comprising a through hole; and
a cable disposed in and axially slidable in the through hole.

2. The apparatus of claim 1, further comprising a sleeve disposed in the through hole, the cable being slidable in the sleeve.

3. The apparatus of claim 2, wherein the sleeve is a first sleeve and the stationary plate comprises a second opening, the apparatus further comprising:
a second guide having a second through hole and being captured in the second opening; and
a second sleeve fixed relative to the second through hole, wherein the cable is disposed through both the first sleeve and the second sleeve and is axially slidable relative to the first sleeve and the second sleeve.

4. The apparatus of claim 3, further comprising a pulley about which the cable is disposed between the first sleeve and the second sleeve.

5. The apparatus of claim 1, wherein the opening comprises a stepped profile with a relatively smaller opening proximate opposing faces of the stationary plate and a relatively larger opening between the relatively smaller openings.

6. The apparatus of claim 5, wherein the stationary plate comprises first and second plates abutting each other, one of the first and second plates having a bore formed on a side abutting the other of the first and second plates, the bore forming the relatively larger opening.

7. The apparatus of claim 6, wherein the guide is disposed in the bore when the first and second plates are abutted.

8. The apparatus of claim 1, further comprising a slot formed through the stationary plate and extending from the opening to a peripheral edge of the stationary plate.

9. The apparatus of claim 1, wherein the cable passes through the stationary plate angled relative to an axis of the opening.

10. A borescope comprising an articulatable tip actuated by a cable, comprising:
first and second cable segments attached to the tip;
a stationary plate spaced from the tip and comprising a first opening and a second opening; and
a first guide captured in the first opening and a second guide captured in the second opening, each of the first guide and the second guide being free to swivel in its respective opening,
wherein the first cable segment is passed through and slidable within the first guide and the second cable segment is passed through and slidable within the second guide.

11. The borescope of claim 10, further comprising a first sleeve surrounding the first cable segment proximate the first guide and a second sleeve surrounding the second cable segment proximate the second guide.

12. The borescope of claim 11, wherein the first sleeve is fixed to the first guide and the second sleeve is fixed to the second guide.

13. The borescope of claim 10, wherein the first opening and the second opening each define an axis, and those axes are angled relative to the respective first and second cable segments.

14. The borescope of claim 10, wherein the stationary plate comprises a plate assembly comprising first and second plates fixed relative to each other.

15. The borescope of claim 10, wherein a first bore is formed substantially coaxially with the first opening in at least one of the first and second plates on a side facing the other of the at least one of the first and second plates and a second bore is formed substantially coaxially with the second opening in at least one of the first and second plates on a side facing the other of the at least one of the first and second plates.

16. The borescope of claim 15, wherein the first bore and the second bore are sized to accept the respective first and second guides.

17. The borescope of claim 16, wherein the first guide is substantially frusto-spherical and an outer diameter of the first guide is smaller than a diameter of the first bore.

18. The borescope of claim 17, wherein a depth of the first bore is greater than the outer diameter of the first guide.

19. The borescope of claim 10, further comprising a slot extending from the first opening to an edge of the stationary plate.

20. The borescope of claim 19, wherein a height of the guide is less than a width of the slot.

21. A borescope comprising:
a tip;
first and second cable segments terminating at the tip and movable to impart a motion on the tip;
a stationary plate spaced from the tip, the stationary plate comprising a first opening having a first axis and a second opening spaced from the first opening and having a second axis;
first and second guides captured in the first opening and the second opening, respectively, each of the first and second guides comprising a through hole having a through hole axis, the first and second guides being freely rotatable within the first and second openings to vary an angle between the respective through hole axis and the first and second axes; and
first and second sleeves disposed in and fixed relative to the through holes of the respective first and second guides, the first cable segment extending through and being slidable with respect to the first sleeve and the second cable segment extending through and being slidable with respect to the second sleeve.
